(19) United States
(12) Patent Application Publication
(10) Pub. No.: US 2012/0124380 A1
(43) Pub. Date: May 17, 2012

(54) USB COMPOSITE DEVICE AND METHOD THEREFOR

(76) Inventors: Zhou Lu, Beijing (CN); Huazhang Yu, Beijing (CN)

(21) Appl. No.: 12/989,671

(22) PCT Filed: Jul. 28, 2010
(86) PCT No.: PCT/CN10/75508

§ 371 Date: Oct. 26, 2010

(30) Foreign Application Priority Data
May 26, 2010 (CN) 201010191950.9

(51) Int. Cl. H04L 9/32; G06F 13/42

(52) U.S. Cl. 713/176; 710/106

(57) ABSTRACT

The invention, which relates to information security device, provides a USB composite device and implementing method thereof. The invention provides a solution that integrates the mass storage function and the key device function on a single device. A USB composite device is connected with a host computer and claims its device type; the composite device receives the operating instruction allocated by the host computer and determines whether the instruction is key device operating instruction; if so, performs key device operating; otherwise, performs data reading/writing operating. Providing higher data security and good usability for the user, the solution of the invention is easy to use.

### FIELD OF THE INVENTION

The invention relates to information security field, and more particularly, relates to USB composite device and method therefor.

### BACKGROUND OF THE INVENTION

A device with two or multiple functions is called a composite device.

The Universal Serial Bus (USB) storage technology has a good usability by using of the USB block transmission protocol. There are two kinds of devices using the technology generally.

The first kind includes mobile storage devices such as disk, compact disk, flash disk, etc.

The second kind includes key device such as software protecting device, identity authentication device, etc. Generally, the key device with USB interface is called USB Key. The USB Key has inbuilt Single Chip Micyoco (SCM) or smart card chip for storing the key or digital certificate of the user and uses algorithm stored in the key device to realize the authentication of the user, which is easy to use and has low cost. The key device has the functions such as email encryption, digital signature, security certificate, safe logon to internet and accessing SSL (Security Socket Layer) web etc. In addition, with the feature that the private key of the user is with the hardware all along, the physical attack is avoided and security is guaranteed.

Though the two kinds of devices are similar in outlook, the functions of them are quite different.

In prior art, the key device can claim itself as Chip/Smart Card Interface Device (CCID) in operation. In addition, the key device can claim itself as Human Interface Device (HID), which makes the key device comply with the HID protocol specification and fulfill all of the functions. Human Interface Device is a USB device which is completely supported by Windows operating system. The application of the host computer running Windows 98 or later version can communicate with Human Interface Device with operating system built-in driver. Therefore, the USB device complied with HID protocol can be easily set up via Windows system.

Communication with key device also can be realized by Small Computer System Interface (SCSI) command. SCSI is an interface standard for the computer to connect a peripheral device, which provides faster speed for data transfer. SCSI reserves extended command for developer. In order to fulfill the function of key device and SCSI communication of the key device, the SCSI extended command is designed to be the command of the key device by the developer.

### SUMMARY OF THE INVENTION

A method for implementing a USB composite device, the method comprising connecting, by the USB composite device, to a host computer and claiming its device type;

receiving, by the USB composite device, operating instruction allocated by the host computer and determining whether the instruction is key device operating instruction;

if the instruction is key device operating instruction, executing the key device operation indicated by the instruction;

otherwise, performing operation of reading/writing data.

Connecting, by the USB composite device, to a host computer and claiming its device type further comprising

claiming, by the USB composite device, itself as a predetermined number of mass storage devices.

The mass storage device comprising disk and compact disk.

The operating instruction allocated by the host computer is enclosed according to SCSI protocol.

Determining, by the USB composite device, whether the instruction is key device operating instruction comprising

determining, by the USB composite device, whether the value of specified field of the operating instruction is predetermined value, if the value of specified field of the operating instruction is predetermined value, the instruction is key device operating instruction; otherwise, the instruction is data reading/writing instruction; or

determining, by the USB composite device, whether the value of specified bit of specified field of the operating instruction is predetermined value, if the value of specified bit of specified field of the operating instruction is predetermined value, the instruction is key device operating instruction; otherwise, the instruction is data reading/writing instruction; or

determining, by the USB composite device, whether the operating instruction is extended SCSI instruction, if the operating instruction is extended SCSI instruction, the instruction is key device operating instruction; otherwise, the instruction is data reading/writing instruction.

The specified field of the operating instruction is LUN field, reserved field or LAB field of the operating instruction;

the specified bit of the specified field of the operating instruction is special bit of LUN field, special bit of reserved filed or reserved bit of other field.

Connecting, by the USB composite device, to a host computer and claiming its device type further comprising

claiming, by the USB composite device, itself as a HID device and a predetermined number of mass storage devices.

Receiving, by the USB composite device, operating instruction allocated by the host computer and determining whether the instruction is key device operating instruction comprising

analyzing and determining, by the composite device, whether the operating instruction is enclosed according to SCSI protocol, if so, the operating instruction is data reading/writing instruction; otherwise the operating instruction is key device operating instruction; or determining, by the composite device, whether the operating instruction is transferred in by USB control transfer channel, if the operating instruction is transferred in by USB control transfer channel, the operating instruction is key device operating instruction; if the operating instruction is not transferred in by USB control transfer channel, the operating instruction is read/write instruction.

Connecting, by the USB composite device, to a host computer and claiming its device type comprising

claiming, by the composite device, as a Chip/Smart Card Interface Device and a predetermined number of mass storage devices.

Receiving, by the USB composite device, operating instruction allocated by the host computer and determining whether the instruction is key device operating instruction comprising

analyzing and determining whether the operating instruction is enclosed according to SCSI protocol, if the operating instruction is enclosed according to SCSI protocol, the operating instruction is read/write instruction; if the operating instruction is not enclosed according to SCSI protocol, the instruction is key device operating instruction.

The key device operation comprising

digital signature, identity authentication and data encryption/decryption.

A USB composite device, wherein the composite device comprising interface module adapted to communicate with a host computer and perform analyzing/enclosure and communication;

instruction determining module adapted to determine operating instruction, which is obtained by analyzing the USB data packet by the interface module, is standard SCSI data reading/writing instruction or key device operating instruction;

data storage module adapted to store data and perform operation of reading/writing data if the operating instruction is standard SCSI data reading/writing instruction; and

key device module adapted to perform key device operation if the operating instruction is key device operating instruction.

The key device module further comprising

digital signature unit adapted to sign the data transferred in according to the signing instruction of the key device operating instruction.

The key device module further comprising

identity authentication unit adapted to perform operation of identity authentication according to the identity authenticating instruction of the key device operating instruction.

The key device module further comprising

data encrypting/decrypting unit adapted to perform operation of encryption/decryption on the data transferred in/out according to the data encrypting/decrypting instruction of the key device operating instruction; and further adapted to perform operation of encryption/decryption on the data transferred in/out from the data storage module.

From what is described above, the advantage is as follows.

1. The functions of mass storage and key device are integrated on one device for the user for the convenient use;

2. The problem that the general key device has limited storage is solved. Mostly, due to the security and cost, the storage size of key device is smaller than that of the general storage device;

3. The security problem of the storage device is solved. Mostly the data stored in the storage device is easily to be obtained. The data can be protected by encrypting the stored data.

### BRIEF DESCRIPTION OF THE DRAWINGS

FIG. 1 is a flow chart of a method for implementing a USB composite device provided by Embodiment 1;

FIG. 2 is a flow chart of a method for implementing a USB composite device provided by Embodiment 2;

FIG. 3 is a flow chart of a method for implementing a USB composite device provided by Embodiment 3;

FIG. 4 is a flow chart of a method for implementing a USB composite device provided by Embodiment 4;

FIG. 5 is a specific structural diagram illustrating of a USB composite device provided by Embodiment 5;

FIG. 6 is a specific hardware structural diagram illustrating of a USB composite device provided by Embodiment 6;

FIG. 7 is a specific hardware structural diagram illustrating of a USB composite device provided by Embodiment 7;

FIG. 8 is a specific hardware structural diagram illustrating of a USB composite device provided by Embodiment 8;

FIG. 9 is a specific hardware structural diagram illustrating of a USB composite device provided by Embodiment 9;

FIG. 10 is a specific hardware structural diagram illustrating of a USB composite device provided by Embodiment 10;

### DETAILED DESCRIPTION OF THE INVENTION

Objects, technical solutions and advantages of the invention will be easily understood by reference to the following description of embodiments when read in conjunction with the accompanying drawings.

### Embodiment 1

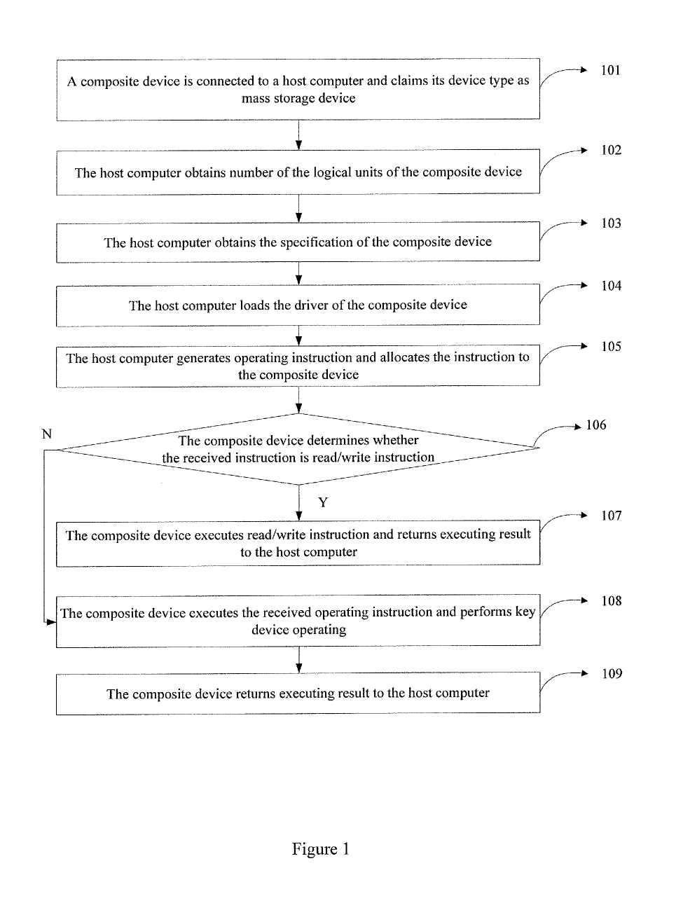

The embodiment provides a method for implementing a USB composite device. The storage function and the key device function of the composite device are implemented by one or more microprocessors. Referring to FIG. 1, the method includes

Step 101, a composite device is connected to a host computer and claims its device type as a mass storage device;

The composite device is connected to the host computer by USB interface; The host computer sends USB enumerating command to the composite device to obtain the type of the composite device;

The composite device reports to the host computer as a mass storage device and supports the interface standard of SCSI protocol.

Step 102, the host computer obtains number of the logical units of the composite device;

USB mass storage device supports a plural of logical units which can be physical storage units or logic address space. Every logical unit is identified by Logical unit Number (LUN).

Specifically, the host computer sends command, which is GETMAX_LUN command, to the composite device for obtaining LUN. The composite device returns the predetermined LUN value to the host computer and the LUN value ranges from 0 to 15.

In the embodiment of the invention, LUN value returned by the composite device to the host computer can be any value from 1 to 15. In the embodiment, the LUN value is supposed to be 1; which represents that the composite device has functions of two types of devices.

Step 103, the host computer obtains the specification of the composite device;

The host computer allocates INQUIRY command to every logical unit according to the LUN number (from 0 to maximum value) of the composite device to inquire specification of the device; and every logical unit is regarded as a separated storage device to respond to INQUIRY command and reports its characteristic.

Upon the received INQUIRY command from the host computer, the composite device sends Unicode including information such as manufacturer, product introduction and type, etc;

The Unicode includes the device type of the mass storage device, such as disk or compact disk, etc. In the embodiment, the composite device claims itself as compact disk.

In addition, if the LUN value returned by the composite device is bigger than 0, that is, the composite device reports to the host computer that the composite device has a plural of logical units, the composite device can claim the plural of logical units as different types in Step 103.

Step 104, the host computer loads the driver of the composite device.

The host computer selects the interface of the device for communication and loads the driver according to the responding information of the composite device.

Step 105, the host computer generates operating instruction and allocates the instruction to the composite device;

If the host computer performs operations, such as reading or writing data, on the composite device, the host computer must generate standard read/write instruction according to the SCSI protocol and allocates the instruction to the composite device;

If the host computer uses the key device function of the composite device, the host computer generates operating instruction according to predetermined rule and then allocates the operating instruction to the composite device.

The key device function of the composite device includes digital signature, data encryption/decryption and identity authentication, etc.

Thereby, when the host computer uses the key device function of the composite device, the allocated instruction can be specified SCSI instruction;

Generally, special SCSI instruction is represented by the special value of the special field or bit in the SCSI instruction. The special field includes LUN field or reserved field; the special bit includes special bit in the LUN field, special bit in the reserved field or reserved bit in other fields;

For example, the SCSI instruction sequence allocated by the host computer is listed as follows:

0×55 53 42 43 28 9b a5 85 00 08 00 00 80 00 0a 28 00 00 00 00 48 00 00 04 00 00 00 00 00 00 00

Thereby, the first four bytes 0×55 53 42 43 indicate that the instruction sequence is SCSI request. The thirteenth byte 0×80 indicates that the composite device need return data to the host computer. If the thirteenth byte is 0×00, it indicates that the host computer will send data to the composite device. The fifteenth byte 0×0a indicates that an SCSI instruction with 10 bytes is followed the fifteenth byte. The SCSI instruction is as follows:

0×28 00 00 00 00 48 00 00 04 00.

In the instruction with 10 bytes, the first byte 0×28, which is operation code, indicates that the SCSI instruction is read 10 instruction (read instruction). If the operation code is 0×2a, the operation code indicates that the SCSI instruction is write 10 instruction (write instruction). The second byte 0×00 is LUN value, which is 0 in the instruction. The third to sixth byte 0×00 00 00 48 indicates the Logical Block Address (LBA).The seventh to ninth byte 0×00 00 04 indicates transfer length. The tenth byte indicates control.

In the embodiment, the instruction customized by the user adapts special field in the SCSI instruction. If the host computer performs operation of writing or reading data on the composite device, the LUN value is 0; if the host computer performs digital signature operation on the composite device, the LUN value is 1.

For example, the instruction sequence allocated by the host computer is as follows: 0×55 53 42 43 28 9b a5 85 00 08 00 00 00 00 0a 2a 01 00 00 a0 e8 00 00 a4 00 00 00 00 00 00 00

In the instruction sequence above, the operation code of SCSI instruction is 0×2a representing Write 10 instruction; the LUN value is 1 representing signing instruction; the thirteenth byte of the instruction sequence is 0×00 representing that the host computer will send data to be signed to the composite device.

The host computer sends the data to be signed to the composite device according to the SCSI protocol upon the allocated instruction.

Step 106, the composite device receives operating instruction, analyzes the received operating instruction, and determines whether the received instruction is read/write instruction;

Specifically, the method that the composite device determines whether the received instruction is read/write instruction includes that

the composite device determines whether the received instruction is read/write instruction according to the value of the special field or the special bit of the field in the SCSI instruction; if so, goes to step 107; otherwise, goes to step 108;

In the embodiment, the composite device determines the value of LUN field, if the value is 0, that is, the SCSI instruction is read/write instruction, goes to step 107; if the value is 1, that is, the SCSI instruction is key device operating instruction, goes to step 108.

Step 107, the composite device executes read/write instruction and returns executing result to the host computer;

In step 106 of the embodiment, if the composite device determines that the value of the LUN field in the received SCSI instruction is 0, the instruction is Read/write instruction. Then the composite device executes read/write instruction and returns the executing result, e.g. the successful information of reading data or writing data, to the host computer.

Step 108, the composite device executes the received operating instruction and performs key device operation;

if the composite device determines that received SCSI instruction is key device operating instruction, the composite device analyzes the received SCSI instruction and determines the specific function of the key device operation such as digital signature, data encryption/decryption and identity authentication, receives data and performs corresponding key device operation on the data according to the key device operating instruction.

In step 106 of embodiment, if the composite device analyzes that the value of the LUN field in the received SCSI instruction is 1, the composite device determines that the instruction is signing instruction, receives data and performs operating of digital signature.

Step 109, the composite device returns executing result to the host computer; the process is ended.

Before the composite device returns the executing result to the host computer, the host computer can allocate instruction to the composite device for obtaining signing result;

for example, the host computer can send special read instruction or predetermined extended SCSI instruction;

and the composite device encloses the executing result according to SCSI protocol and returns the enclosed executing result to the host computer.

In the embodiment, the instruction that the host computer allocates the instruction for obtaining the executing result is as follows:

0×55 53 42 43 28 9b a5 85 00 08 00 00 80 00 0a 28 01 00 00 a0 e8 00 00 a4 00 00 00 00 00 00 00.

In the embodiment, the key device function of the composite device includes at least one of the functions like digital signature, identity authentication, and data encryption/decryption;

for example, if the LUN value, for responding to the GET-MAX-LUN command from the host computer, returned by the composite device is 4;

correspondingly, if the LUN value in the SCSI instruction is 0, the instruction is read/write instruction; if the LUN value is 1, the instruction is signing instruction; if the LUN value is 2, the instruction is data encryption instruction; if the LUN value is 3, the instruction is data decryption instruction; if the LUN value is 4, the instruction is identity authentication instruction;

correspondingly, the method for implementing function of identity authentication or data encryption/decryption, etc., can refer to the method for implementing digital signature function above.

The method for data encryption/decryption includes encryption/decryption with customized algorithms and standard algorithms;

the standard algorithms include RSA, DES, 3DES, MD5, SHA-1, SSF33, AES, ECC, RC, PGP, and BASE64;

and the customized algorithms are defined by the user.

From what is described above, it can be inferred that the composite device connected to the operating system is recognized as a general storage device with key device function. The advantage is as follows.

1. The functions of storage and key device are integrated on one device for the user, which is convenient to use;

2. Mostly, due to the security and cost, the storage size of key device is smaller than that of the general storage device. The problem that the general key device has limited storage is solved.

3. The security problem of the storage device is solved. Mostly the data stored in the storage device is easily to be obtained. The data can be protected by encrypting the stored data.

4. The composite device is compatible with the interfaces provided by all kinds of operating systems.

### Embodiment 2

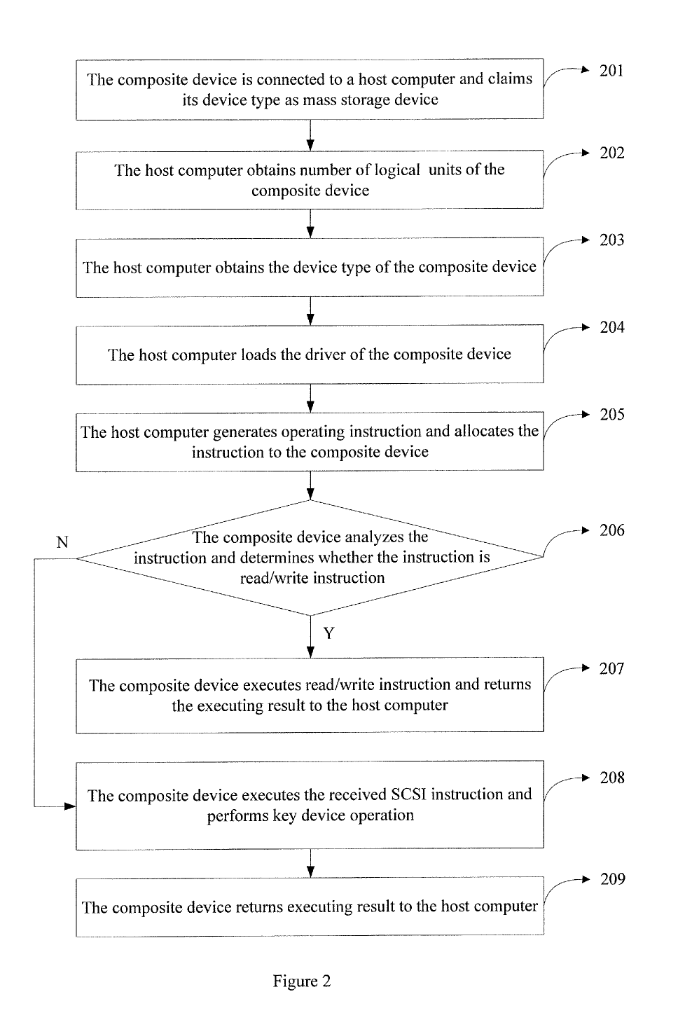

The embodiment provides a method for implementing a composite device. The method integrates the storage function and the key device function on one composite device. The storage function and the key device function are implemented by a micro-processor chip or a plural of micro-processor chips. Referring to FIG. 2, the steps of the method include

Step 201, the composite device is connected to a host computer and claims its device type as mass storage device;

The composite device is connected to the host computer via USB interface; The host computer sends enumerating instruction to the composite device to obtain the type of the composite device;

Upon the received enumerating instruction allocated by the host computer, the composite device reports to the host computer as mass storage device and supports SCSI protocol.

Step 202, the host computer obtains number of logical units of the composite device; Specifically, the host computer sends GET_MAXLUN command to the host computer to obtain LUN; the composite device returns predetermined LUN value to the host computer; the LUN value ranges from 0 to 15.

In the embodiment, the LUN value that the composite device sends to the host computer is 0, which indicates that the composite device has only one logical unit. Step 203, the host computer obtains the specification of the composite device;

The host computer allocates INQUIRY command to every logical unit according to the sequence of LUN number(from 0 to the maximum number) to inquire specification of the device; every logical unit is regarded as a separated storage to respond to INQUIRY command and reports characteristic of every storage device.

Upon the received INQUIRY command from the host computer, the composite device sends Unicode including information such as manufacturer, product introduction and type, etc to the host computer;

The Unicode includes the device type of the mass storage device, such as disk or compact disk, etc. In the embodiment, the composite device claims itself as disk.

Step 204, the host computer loads the driver of the composite device.

The host computer selects communicating interface and loads the driver of the device according to the responding information of the composite device in the step above.

Step 205, the host computer generates operating instruction and allocates the instruction to the composite device;

The instruction for the communication between the host computer and the composite device is enclosed according to the SCSI protocol.

If the host computer performs operation of writing or reading data on the composite device, the host computer generates standard write or read instruction according to SCSI protocol and allocates the instruction to the composite device;

If the host computer uses the key device function of the composite device, the host computer generates instruction according to predetermined rule and allocates the instruction to the composite device.

Thereby, the key device function of the composite device includes digital signature, data encryption/decryption, identity authentication, etc.

Specifically, when the host computer uses key device function of the composite device, the allocated instruction is SCSI instruction for accessing specified location on the disk;

The specified location on the disk includes special file of the disk or specified sector of the disk, etc;

The specified file or specified sector of the composite device is predetermined.

For example, the signing instruction allocated by the composite device is as follows: 0×55 53 42 43 28 9b a5 85 00 08 00 00 00 00 0a 2a 00 aa aa aa aa 00 00 a4 00 00 00 00 00 00 00

In the instruction above, the host computer indicates that the SCSI instruction is a signing instruction by a special LBA address 0×aa aa aa aa;

upon allocating the instruction above, the host computer sends the data to be signed to the composite device.

Step 206, the composite device receives the operating instruction, analyzes the instruction and determines whether the instruction is read/write instruction;

if the instruction is read/write instruction, go to step 207; otherwise, the instruction is key device operating device, go to step 208.

The composite device determining whether the instruction is read/write instruction is that

the composite device parses the instruction and determines whether the instruction is for accessing specified file or specified sector of the disk, if so, the instruction is key device operating instruction; otherwise, the instruction is read/write instruction.

Specifically, in the embodiment, the composite device can determine that the instruction is signing instruction according to the LBA address, which is 0×aa aa aa aa, in the instruction.

Upon determining that the instruction is signing instruction, the composite device receives the data to be signed sent from the host computer.

Step 207, the composite device executes read/write instruction and returns the executing result to the host computer;

In step 206 of the embodiment, if the composite device determines that the received SCSI instruction is read/write instruction, the composite device reads or writes data according to the SCSI instruction and then returns the executing result (the successful information of reading or writing data) to the host computer.

Step 208, the composite device executes the received SCSI instruction and performs key device operation;

If the composite device determines that the received SCSI instruction is key device operating instruction, the composite device performs corresponding key device operation such as digital signature, data encryption/decryption or identity authentication, etc;

If the SCSI instruction received in step 206 is signing instruction, the composite device performs operation of digital signature on the data to be signed in the instruction in step 206.

Step 209, the composite device returns the executing result to the host computer; the process is ended.

Before the composite device returns the executing result to the host computer, the host computer can allocate instruction of obtaining signing result to the composite device;

In the embodiment, the allocated instruction of obtaining signing result is as follows:

0×55 53 42 43 28 9b a5 85 00 08 00 00 80 00 0a 28 01 aa aa aa aa 00 00 a4 00 00 00 00 00 00 00

Upon receiving the instruction of obtaining the signing result, the composite device encloses the executing result according to the SCSI protocol and returns the enclosed result to the host computer.

In the embodiment, the key device function of the composite device includes at least one of the functions like digital signature, identity authentication, data encryption/decryption, etc.;

For example, the key device function can be distinguished from each other by different LBA.

The method of data encryption/decryption includes encryption/decryption by customized algorithms and standard algorithms;

The standard algorithms include RSA, DES, 3DES, MD5, SHA-1, SSF33, AES, ECC, RC, PGP, and BASE64;

The customized algorithms are defined by the user.

From what is described above, it can be inferred that the composite device connected to the operating system is recognized as a general storage device with key device function. The advantage is as follows.

1. The functions of storage and key device are integrated on one device for the user for the convenient use;

2. The problem that the general key device has limited storage is solved. Mostly, due to the security and cost, the storage size of key device is smaller than that of the general storage device;

3. The security problem of the storage device is solved. Mostly the data stored in the storage device is easily to be obtained. The data can be protected by encrypting the stored data.

4. The composite device is compatible with the interfaces provided by all kinds of present operating systems.

### Embodiment 3

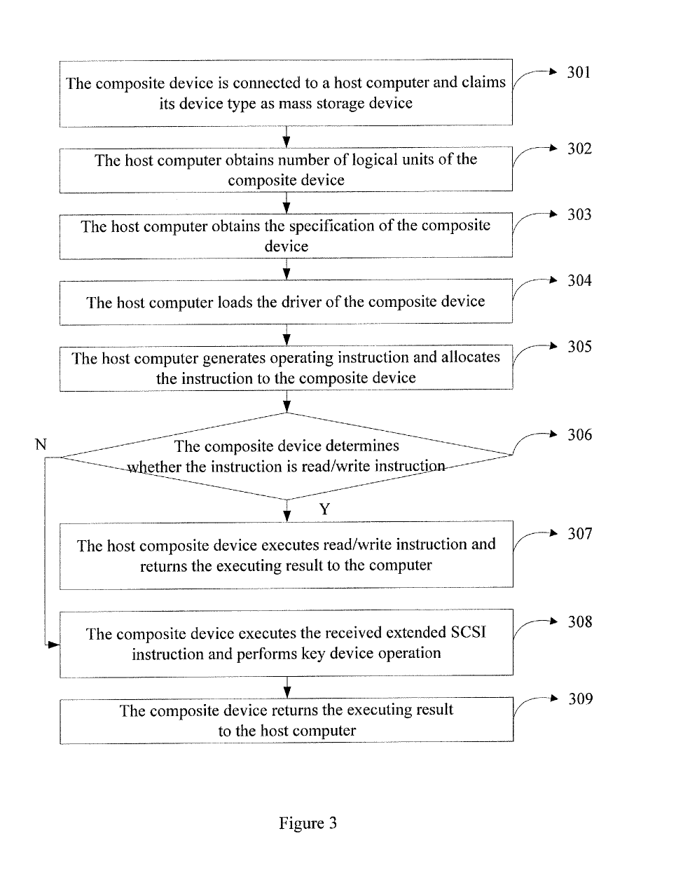

The embodiment provides a method for implementing a composite device. The method integrates the storage function and the key device function on one composite device. The storage function and the key device function are implemented by a micro-processor chip or a plural of micro-processor chips. Referring to FIG. 3, the steps of the method include

Step 301, the composite device is connected to a host computer and claims its device type as mass storage device;

the composite device is connected to the host computer via USB interface; the host computer sends enumerating instruction to the composite device to obtain the type of the composite device;

upon the received enumerating instruction allocated by the host computer, the composite device reports to the host computer as mass storage device and supports SCSI protocol.

Step 302, the host computer obtains number of logical units of the composite device;

specifically, the host computer sends GET_MAX_LUN command to the host computer to obtain LUN; the composite device returns predetermined LUN value to the host computer; the LUN value ranges from 0 to 15.

In the embodiment, the LUN value that the composite device sends to the host computer is 0, which indicates that the composite device has only one logical unit.

Step 303, the host computer obtains the specification of the composite device;

the host computer allocates INQUIRY command to every logical unit according to the sequence of LUN number (from 0 to the maximum number) to inquire specification of the device; every logical unit is regarded as a separated storage to respond to INQUIRY command and reports characteristic of every storage device.

Upon the received INQUIRY command from the host computer, the composite device sends Unicode including information such as manufacturer, product introduction and type, etc., to the host computer;

the Unicode includes the device type of the mass storage device, such as disk or compact disk, etc. In the embodiment, the composite device claims itself as disk.

Step 304, the host computer loads the driver of the composite device.

The host computer selects communicating interface and loads the driver of the device according to the responding information of the composite device in the step above.

Step 305, the host computer generates operating instruction and allocates the instruction to the composite device;

the instruction for the communication between the host computer and the composite device is enclosed according to the SCSI protocol.

If the host computer performs operation of writing or reading data on the composite device, the host computer generates standard write or read instruction according to SCSI protocol and allocates the instruction to the composite device;

if the host computer uses the key device function of the composite device, the host computer generates instruction according to predetermined rule and allocates the instruction to the composite device.

Thereby, the key device function of the composite device includes digital signature, data encryption/decryption, identity authentication, etc.

Specifically, when the host computer uses key device function of the composite device, the allocated instruction is extended SCSI instruction;

the extended SCSI instruction refers to the SCSI instruction sequence with operation code of which the usage and the meaning is not regulated in the SCSI protocol; the host computer controls the composite device to perform a plural of key device functions by the predetermined extended SCSI instruction.

For example, the signing instruction allocated by the composite device is as follows:

0×55 53 42 43 28 9b a5 85 00 08 00 00 00 00 0a ee 0e 34 00 4a 00 00 00 a4 00 00 00 00 00 00 00

Referring to the instruction above, in the ten bytes following 0×0a, the first operation code 0×ee is not used in the standard SCSI protocol, which indicates that the SCSI instruction above is an extended SCSI instruction; the values of the rest 9 bytes following the operation code can be predetermined values or random numbers;

upon allocating the instruction above, the host computer sends the data to be signed to the composite device.

In addition, the composite device has other key device functions besides the digital signature function, such as data encryption etc, So that the host computer generates different instructions for different key device functions by using different operation code or different data of the nine bytes following the operation code.

Step 306, the composite device receives the operating instruction, analyzes the instruction and determines whether the instruction is read/write instruction;

if the instruction is read/write instruction, goes to step 307; otherwise, the instruction is key device operating instruction, goes to step 308.

The composite device determining whether the instruction is read/write instruction is that

the composite device determines whether the instruction is extended SCSI instruction, if so, the instruction is key device operating instruction; otherwise, the instruction is read/write instruction.

Specifically, in the embodiment, the composite device can determine that the instruction is extended SCSI instruction, specifically, a signing instruction, according to the operation code 0×ee in the instruction.

Upon determining that the instruction is signing instruction, the composite device receives the data to be signed sent from the host computer.

Step 307, the composite device executes read/write instruction and returns the executing result to the host computer;

in step 306 of the embodiment, if the composite device determines that the received instruction is read/write instruction according to the SCSI protocol, the composite device reads or writes data according to the instruction and then returns the executing result (the successful information of reading or writing data) to the host computer.

Step 308, the composite device executes the received extended SCSI instruction and performs key device operation;

if the composite device determines that the received SCSI instruction is extended SCSI instruction, the composite device performs corresponding key device operation, such as digital signature, data encryption/decryption or identity authentication, etc;

in the embodiment, the instruction received in step 306 is signing instruction. The composite device performs operation of digital signature on the data to be signed in the instruction in step 206.

Step 309, the composite device returns the executing result to the host computer; the process is ended.

Before the composite device returns the executing result to the host computer, the host computer may allocate instruction of obtaining signed result to the composite device;

in the embodiment, the allocated instruction of obtaining the signed result is as follows:

0×55 53 42 43 28 9b a5 85 00 08 00 00 80 00 0a dd 00 00 00 00 00 00 00 a4 00 00 00 00 00 00 00

Or, the host computer modifies the allocated former signing instruction, that is, modifies the thirteenth byte 0×00 in the instruction above to be 0×80. The modified instruction indicates that the composite device needs to return data, the signed result, to the host computer. The instruction for obtaining the signed result is as follows:

0×55 53 42 43 28 9b a5 85 00 08 00 00 80 00 0a ee 0e 34 00 4a 00 00 00 a4 00 00 00 00 00 00 00

Alternatively, the 9 bytes following the operation code can also be used to indicate that the extended instruction, which is disfferent from the signing instruction, is for obtaining the signed result. Correspondingly, the instruction for obtaining the signed result can be as follows:

0×55 53 42 43 28 9b a5 85 00 08 00 00 80 00 0a ee 0e 34 00 4a 00 00 00 a4 00 00 00 00 00 00 00

Upon the received instruction for obtaining the signed result, the composite device encloses the executing result according to the SCSI protocol and returns the enclosed executing result to the host computer.

In the embodiment, the key device function of the composite device includes at least one of the functions like digital signature, identity authentication, data encryption/decryption, etc;

The method of data encryption/decryption includes encryption/decryption with customized algorithms and standard algorithms;

the standard algorithms include RSA, DES, 3DES, MD5, SHA-1, SSF33, AES, ECC, RC, PGP, and BASE64;

the customized algorithms are defined by the user.

From what is described above, it can be inferred that the composite device connected to the operating system is recognized as a general storage device with key device function. The advantage is as follows.

1. The functions of storage and key device are integrated on one device for the user for the convenient use.

2. The problem that the general key device has limited storage is solved. Mostly, due to the security and cost, the storage size of key device is smaller than that of the general storage device.

3. The security problem of the storage device is solved. Mostly the data stored in the storage device is easily to be obtained. The data can be protected by encrypting the stored data.

4. The composite device is compatible to the interfaces provided by all kinds of present operating systems.

### Embodiment 4

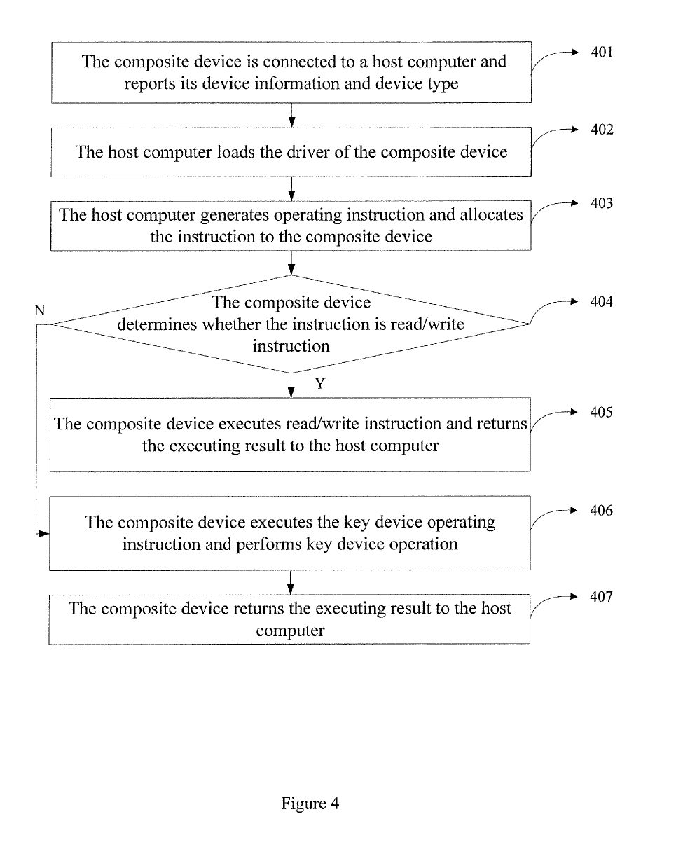

The embodiment provides a method for implementing a USB composite device. The storage function and the key device function are implemented by a micro-processor chip or a plural of micro-processor chips. Referring to FIG. 4, the steps of the method include

Step 401, the composite device is connected to a host computer and reports its device information and device type;

the composite device connects to the host computer via USB interface and the host computer sends USB enumerating command to the composite device to obtain the device type of the composite device.

The composite device receives the enumerating command allocated by the host computer and reports itself as a mass storage device supporting SCSI protocol and Human Interface Device (HID) or reports itself as a mass storage device supporting SCSI protocol and USB Chip/Smart Card Interface Device (CCID).

In the embodiment, the mass storage device can include one or more than 1 but less than 17 logical units. The device type of every logical unit can be disk or compact disk.

Step 402, the host computer loads the driver of the composite device.

According to the responding information from the composite device, the host computer selects corresponding communication interface protocol and loads device driver.

Step 403, the host computer generates operating instruction and allocates the instruction to the composite device;

if the host computer performs operation of reading or writing data on the composite device, the host computer generates read/write instruction according to SCSI protocol and allocates the instruction to the composite device via batch transfer channel;

if the host computer uses the key device function of the composite device, the host computer calls PCSC (Personal Computer/Smart Card) interface to generate APDU(Application Protocol Data Unit) instruction of 7816 protocol and encloses the APDU instruction according to HID protocol and allocates the enclosed instruction to the composite device via control transfer channel;

or

if the host computer uses the key device function of the composite device, the host computer calls PCSC interface to generate APDU instruction of 7816 protocol and encloses the APDU instruction according to CCID protocol and allocates the enclosed instruction to the composite device via batch transfer channel.

Thereby, the key device function of the composite device includes digital signature, data encryption/decryption and identity authentication, etc.

For example, the host computer calls PCSC interface to generate an APDU instruction. The instruction is for obtaining random number as follows:

0×00 84 00 00 08

Then, the host computer encloses the received data according to the instruction header regulated in CCID protocol and the instruction header is as follows:

0×6f 05 00 00 00 00 10 00 00 00

The enclosed instruction is 0×6f 05 00 00 00 00 10 00 00 00 00 84 00 00 08

Step 404, the composite device receives operating instruction and analyzes the received operating instruction and determines whether the instruction is read/write instruction;

If the instruction is read/write instruction, goes to step 405; otherwise the operating instruction is key device operating instruction, goes to step 406.

Specifically, the step that the composite device determines whether the received instruction is read/write instruction includes that

the composite device determines whether the received instruction is enclosed according to SCSI protocol, if so, the operating instruction is read/write instruction based on SCSI protocol; otherwise, the operating instruction is key device operating instruction enclosed according to HID protocol or CCID protocol;

or

if the composite device claims the device as Human Interface Device or mass storage device complied by SCSI protocol, the composite device determines whether the received operating instruction is transferred by the control transfer channel, if so, the operating instruction is key device operating instruction enclosed according to HID protocol; otherwise the instruction is read/write instruction of SCSI protocol.

Step 405, the composite device executes read/write instruction and returns the executing result to the host computer;

In the embodiment, the step 404 determines that the received SCSI instruction is read/write instruction, the composite device performs operation of reading or writing data and returns the executing result (the successful information of reading or writing data) to the host computer.

Step 406, the composite device executes the key device operating instruction and performs key device operation;

If the composite device determines that the operating instruction received is key device operating instruction, the composite device parses the operating instruction and performs corresponding key device operation, such as digital signature, data encryption/decryption or identity authentication, etc.

For example, the composite device analyzes the received CCID instruction 0×6f 05 00 00 00 00 10 00 00 00 00 84 00 00 08 to obtain the APDU instruction 84 00 00 08. Then the composite device performs operation of obtaining random number.

Step 407, the composite device returns the executing result to the host computer; and the process is ended.

The composite device encloses the executing result of executing key device operating instruction according to HID protocol and returns the enclosed executing result to the host computer via interrupt transfer channel;

or

the composite device encloses the executing result of executing key device operating instruction according to CCID protocol and returns the enclosed executing result to the host computer via interrupt transfer channel.

In the embodiment, the key device function of the composite device has at least one of the functions including digital signature, identity authentication and data encryption/decryption, etc.

From what is described above, the device provided by the embodiment 4 claims itself as a mass storage device and Human Interface Device or a mass storage device and Chip/Smart Card Interface Device (CCM). The advantage is that

1. a user can access the composite device via a host computer conveniently and manage the composite device easily because the composite device is compatible to interfaces to all kinds of the present operation systems;

2. With the convenient usability, the user needs only one device to use the storage and key device functions;

3. Mostly, due to the security and cost, the storage size of key device is smaller than that of the general storage device. The problem that the general key device has limited storage is solved.;

4. In order to solve the security problem of the storage device, that is ,the data stored in the storage device can be obtained easily, the solution provided by the invention can encrypt the stored data in order to protect the data.

### Embodiment 5

The embodiment provides a USB composite device. The storage function and the key device function integrated on the composite device are implemented by one or a plural of microprocessors.

Referring to FIG. 5, the embodiment provides the USB composite device 500 which includes

USB interface module 501, instruction determining module 502, data storage module 503 and key device module 504.

The USB interface module 501 is adapted to connect the USB composite device 500 and a host computer and perform parsing/enclosure and communication based on USB protocol.

The instruction determining module 502 is adapted to determine whether the operating instruction, which is obtained by analyzing the USB data packet by the USB interface module 501, is standard SCSI read/write instruction or key device operating instruction, and send the standard SCSI read/write instruction to the data storage module 503 or send the key device operating instruction to the key device module 504.

The data storage module 503 is adapted to store data and perform operation of reading/writing data.

The key device module 504 is adapted to perform corresponding key device operation according to the key device operating instruction.

Thereby, the key device operation includes digital signature and/or identity authentication and/or data encryption/decryption, etc;

correspondingly, the key device module includes digital signature unit 504A, identity authentication unit 504B, data encryption/decryption unit 504C;

the digital signature unit 504A is adapted to sign the received data according to the signing instruction;

the identity authentication unit 504B is adapted to perform identity authentication according to the identity authentication instruction;

and the data encryption/decryption unit 504C is adapted to encrypt/decrypt data transferred in, and return the encrypted data or decrypted data to the host computer or send the encrypted/decrypted data to the storage module 503; further adapted to encrypt/decrypt the data read from the storage module 503 and then return the encrypted/decrypted data to the host computer.

The USB composite device 500 connects with the host computer via the USB interface module 501 and claims itself as predetermined number of mass storage devices; the USB interface module 501 receives USB data packet allocated by the host computer and parses the USB data packet to obtain operating instruction; the instruction determining module 502 determines whether the operating instruction is key device operating instruction; if the instruction is key device operating instruction, the key device module performs corresponding key device operation according to the instruction; otherwise, the parsed data is transferred to data storage module 503 and the data storage module 503 performs operation of reading/writing data.

The USB composite device 500 further performs operation of storing encrypted data. After that the USB interface module 501 receives the read instruction allocated by the host computer, the data storage module 503 executes the read instruction to read the encrypted data, the data encryption/decryption unit 504C of the key device module 504 decrypts the encrypted data and sends the decrypted data to the host computer via the USB interface module 501.

The embodiment of the invention provides a USB composite device with storage function of USB disk and key device function of USB Key. With good usability and portability, the USB composite device applies the present interface technology, which provides the advantage that no need of modifying the host computer system.

### Embodiment 6

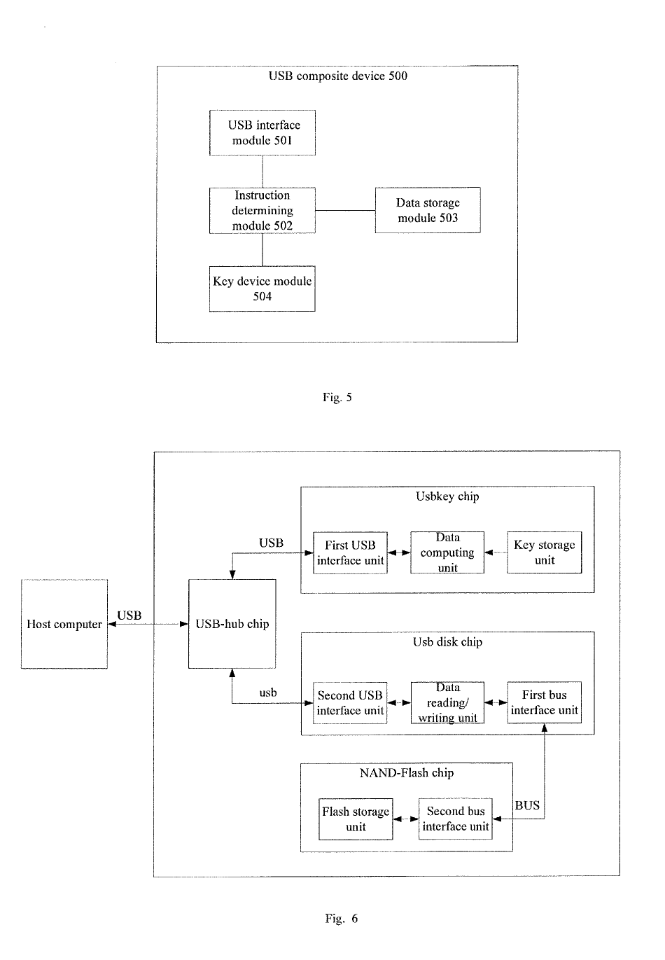

The embodiment provides a USB composite device with storage function of USB disk and key device function of USB Key. Referring to FIG. 6, the USB composite device includes USB-hub chip, USB Key chip, USB disk chip and NAND-Flash chip.

The USB-Hub chip is connected to a host computer, USB Key chip and USB disk chip respectively;

the USB Key chip, implementing the key device function, such as data encryption/decryption or digital signature, etc, is adapted to communicate with the host computer according to USB protocol via USB-hub chip;

and the USB disk chip, connected with NAND-Flash chip, is adapted to control NAND-Flash chip, which is mass flash chip, to perform operation of writing data or reading data etc.

Specifically, the USB Key chip includes first USB interface unit, data computing unit, key storage unit. The USB disk chip includes second USB interface unit, data reading/writing unit and first bus interface unit. The NAND-Flash chip includes Flash storage unit and second bus interface unit;

the first USB interface unit is adapted to parse or enclose data according to USB protocol, and to communicate with the host via USB-Hub chip according to USB protocol;

the data computing unit is adapted to read key from the key storage unit according to the received operating instruction and perform key device function, such as data encryption/decryption, digital signature etc., indicated by the operating instruction;

the key storage unit is adapted to store the key of the user;

the second USB interface unit is adapted to parse or enclose data according to USB protocol and perform communication with the computer via USB-Hub chip according to USB protocol;

the data reading/writing unit is adapted to send instruction to the Flash storage unit of the NAND-Flash chip and perform operations of reading/writing data according to the received read/write instruction;

the first bus interface unit, which is connected with the second bus interface, is adapted to communicate with NAND-Flash chip according to bus interface protocol;

the Flash storage unit is adapted to store data and execute read/write instruction sent from USB disk chip and return the read data or the executing result to the USB disk chip;

and the second bus interface unit, which is connected with the first bus interface unit of the USB disk chip, is adapted to communicate with the USB disk chip according to the bus interface protocol.

### Embodiment 7

The embodiment provides a USB composite device with storage function of USB disk and key device function of USB key. Referring to FIG. 7, the composite USB device includes USB disk control chip, USB key chip and NAND-Flash chip.

The USB disk control chip is connected with host computer, USB Key chip and NAND-Flash chip respectively;

the USB disk control chip integrates the functions of USB disk chip and Usb-Hub chip of embodiment 6. The USB Key chip communicates with the host computer via the USB disk control chip based on USB protocol;

and the USB key chip is adapted to implement key device functions such as data encryption/decryption and digital signature, etc.

The USB disk control chip, which is connected with NAND-Flash chip, is adapted to control the NAND-Flash chip to perform operations such as reading data and writing data, etc.

Specifically, the USB disk control chip includes USB-Hub unit, first USB interface unit, data reading/writing unit, first bus interface unit; the USB Key chip includes second USB interface unit, data computing unit and key storage unit; and the NAND-Flash chip includes Flash storage unit and second bus interface unit.

The first USB interface unit is adapted to parse or enclose data and communicate with the host computer according to the USB protocol;

the data reading/writing unit is adapted to send instruction to the Flash storage unit of the NAND-Flash chip and perform operation of reading/writing data according to the received read/write instruction;

the first bus interface unit, which is connected with the second bus interface unit of the NAND-Flash chip, is adapted to communicate with the NAND-Flash chip according to the bus interface protocol;

the second USB interface unit is adapted to parse or enclose data and communicate with the host computer via the USB-Hub unit of the USB disk control chip according to the USB protocol;

the data computing unit is adapted to read key from the key storage unit according to the received operating instruction and perform key device functions, such as data encryption/decryption, digital signature etc., indicated by the operating instruction;

the key storage unit is adapted to store the key of the user;

the Flash storage unit is adapted to store data and execute read/write instruction sent from the USB disk control chip and return the read data or executing result to the USB disk control chip;

and the second bus interface unit, which is connected with the first bus interface unit of the USB control chip, is adapted to communicate with the USB disk control chip according to the BUS interface protocol.

### Embodiment 8

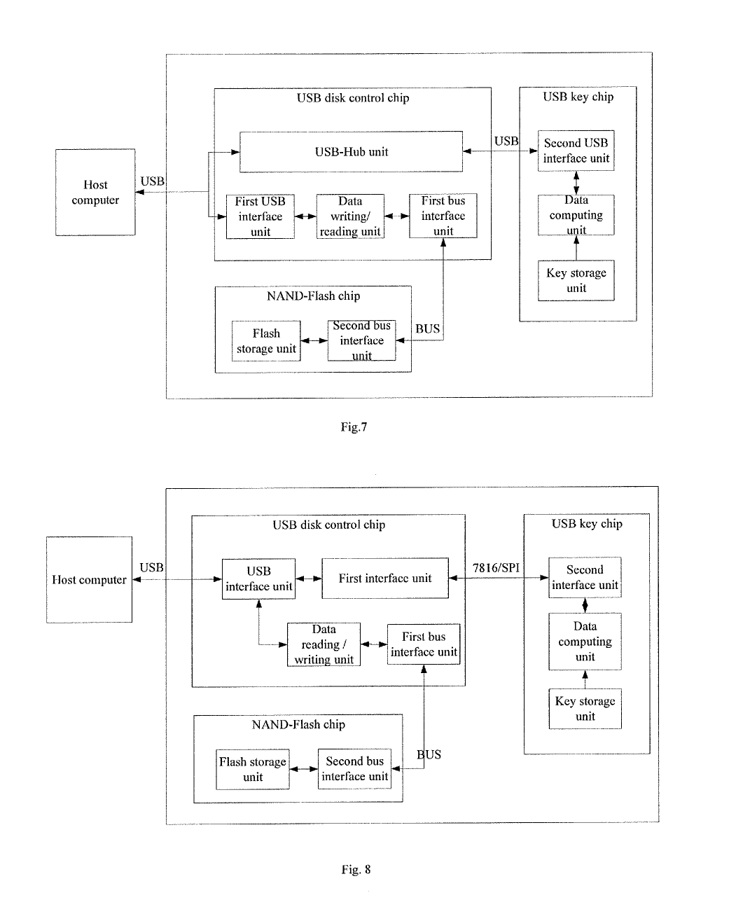

The embodiment provides a USB composite device with storage function of USB disk and key function of USB key. Referring to FIG. 8, the composite USB device includes USB disk control chip, USB Key chip and NAND-Flash chip.

Thereby, the USB disk control chip is connected with the host computer, USB Key chip and NAND-Flash chip respectively;

The USB disk control chip provided by the embodiment integrates the function of the USB disk chip of embodiment 6 and the function of data enclosure and parsing. The USB disk control chip communicates with the host computer according to the USB protocol and communicates with the USB Key chip according to 7816 protocol or SPI protocol;

The USB disk control chip is further adapted to control the NAND-Flash chip to perform operations of reading and writing data, etc.

The USB key chip is adapted to implement key device functions such as data encryption/decryption and digital signature, etc.

Specifically, the USB disk control chip includes USB interface unit, first interface unit, data reading/writing unit, first bus interface unit; the USB Key chip includes second interface unit, data computing unit and key storage unit; the NAND-Flash chip includes Flash storage unit and second bus interface unit;

the USB interface unit is adapted to parse the data allocated by the host computer according to USB protocol and send the parsed data to the first interface unit or data reading/writing unit, or to enclose the data returned by the first interface unit or data reading/writing unit to the host computer;

the first interface unit is adapted to provide 7816 interface or Serial Peripheral Interface (SPI) for the data communication between the USB disk control chip and the USB Key chip;

the data reading/writing unit is adapted to send instruction to the Flash storage unit of the NAND-Flash chip according the read/write instruction and perform operation of reading/writing data;

the first bus interface unit, which is connected with the second bus interface unit of NAND-Flash chip, is adapted to communicate with the NAND-Flash chip according to the bus interface protocol;

the second USB interface unit is adapted to parse or enclose the data according to the USB protocol and communicate with the host computer via the USB-Hub unit of the USB disk control chip;

the data computing unit is adapted to read key from the key storage unit according to the received operating instruction and perform key device functions, such as data encryption/decryption, digital signature etc., indicated by the operating instruction;

the key storage unit is adapted to store the key of the user;

the Flash storage unit is adapted to store data and execute read/write instruction sent from the USB disk control chip and return the read data or the executing result to the USB disk control chip;

and the second bus interface unit, which is connected with the first bus interface unit of the USB control chip, is adapted to communicate with the USB control chip according to the BUS interface protocol.

### Embodiment 9

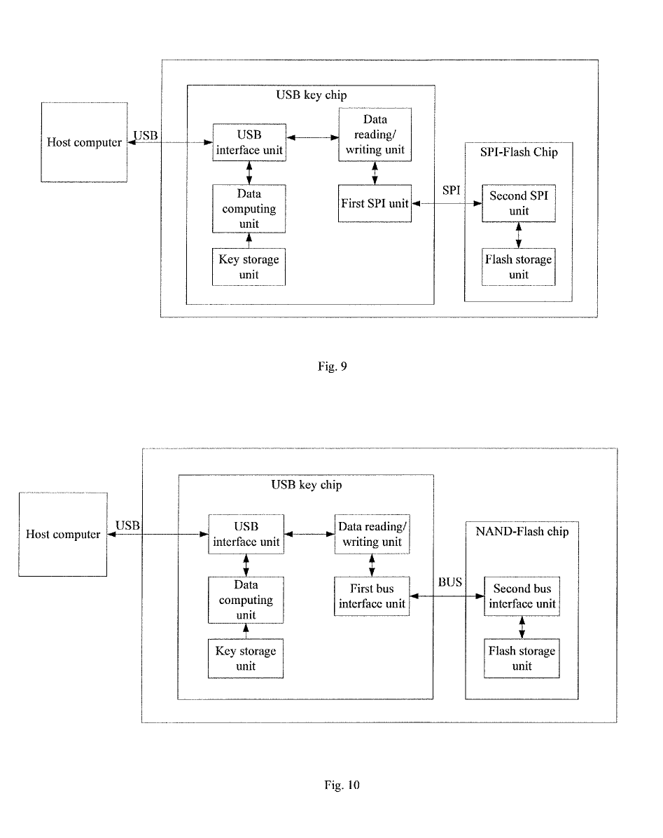

The embodiment provides a USB composite device with storage function of USB disk and key device function of USB key. Referring to FIG. 9, the USB composite device includes USB key chip and SPI-Flash chip.

Thereby, the USB Key chip is connected with a host computer and the SPI-Flash chip respectively;

the USB Key chip, integrated the functions of Flash reading/writing control function and key device function, controls the SPI-Flash chip to perform the operation of reading/writing data via Serial Peripheral Interface (SPI).

The SPI-Flash chip is a flash chip using Serial Peripheral Interface. Generally, the capacity of SPI-Flash chip is smaller than that of NAND-Flash chip.

Specifically, the USB Key chip includes USB interface unit, data computing unit, key storage unit, data reading/writing unit and first SPI unit; the SPI-Flash chip includes Flash storage unit and second SPI unit;

the USB interface unit is adapted to parse the data allocated by the host computer according to USB protocol and send the parsed data to the first SPI interface unit or data reading/writing unit, or to enclose the data returned by the second SPI interface unit or data reading/writing unit to the host computer;

the data computing unit is adapted to read key from the key storage unit according to the received operating instruction and perform key device operation, such as data encryption/decryption, digital signature etc., indicated by the operating instruction;

the key storage unit is adapted to store the key of the user;

the data reading/writing unit is adapted to send instruction to the Flash storage unit of the NAND-Flash chip and perform operations of reading/writing data according to the received read/write instruction;

the first SPI unit, is adapted to provide Serial Peripheral Interface(SPI) and enclose or parse data according to SPI protocol for data exchange between the USB Key chip and the SPI-Flash chip;

the Flash storage unit is adapted to store data and execute read/write instruction sent from USB disk chip and return executing result to the read data or the executing result to the USB disk chip;

and the second SPI unit, is adapted to provide Serial Peripheral Interface and enclose or parse the data according to SPI protocol for communication between the USB Key chip and the SPI-Flash chip.

### Embodiment 10

The embodiment provides a USB composite device with storage function of USB disk and key function of USB key. Referring to FIG. 10, the composite USB device includes USB key chip and NAND-Flash chip.

Thereby, the USB Key chip is connected with a host computer and NAND-Flash chip respectively;

the USB Key chip, integrated with the function of USB disk chip, controls the Flash storage unit of the NAND-Flash chip to perform operations, such as reading or writing data, etc., via bus interface.

Specifically, the USB Key chip includes USB interface unit, data computing unit, key storage unit, data reading/writing unit, and first bus interface unit; the NAND-Flash chip includes Flash storage unit and second bus interface unit;

the USB interface unit, is adapted to parse the data allocated by the host computer according to the USB protocol and send the parsed data to the first bus interface unit or data reading/writing unit; or to enclose the data returned by the second bus interface unit and the data reading/writing unit according to the USB protocol and send the enclosed data to the host computer;

the data computing unit is adapted to read key from the key storage unit according to the received operating instruction and perform key device operation, such as data encryption/decryption, digital signature etc., indicated by the operating instruction;

the key storage unit is adapted to store the key of the user;

the data reading/writing unit is adapted to send instruction to the Flash storage unit of the NAND-Flash chip and perform operations of reading/writing data according to the received read/write instruction;

the first bus interface unit, which is connected with the second bus interface of NAND-Flash chip, is adapted to communicate with NAND-Flash chip according to the bus interface protocol;

and the Flash storage unit is adapted to store data and execute read/write instruction sent by USB Key chip and return the read data or the executing result to the USB Key chip.

The second bus interface unit, which is connected with the first bus interface unit of the USB Key chip, is adapted to exchange data with the USB Key chip according to the bus interface protocol.

From what described above, it can be inferred that the composite device connected to the operating system is recognized as a device with many types and massive storage device and key device function. The advantage is as follows.

1. The functions of storage and key device are integrated on one device for the user for the convenient use.

2. The problem that the general key device has limited storage is solved. Mostly, due to the security and cost, the storage size of key device is smaller than that of the general storage device.

3. The security problem of the storage device is solved. Mostly the data stored in the storage device is easily to be obtained. The data can be protected by encrypting the storage device with key device by some algorithms or API.

4. The composite device is compatible to the interface provided by all kinds of present operating systems.

The presently disclosed embodiments should be considered in all respects to be illustrative and not restrictive. The scope of the invention is indicated by the appended claims rather than the foregoing description, and all variations which come within the meaning and range of equivalents thereof are intended to be embraced therein.

1. A method for implementing a USB composite device, the method comprising
connecting, by the USB composite device, to a host computer and claiming its device type;
receiving, by the USB composite device, operating instruction allocated by the host computer and determining whether the instruction is key device operating instruction;
if the instruction is key device operating instruction, executing the key device operation indicated by the instruction;
otherwise, performing operation of reading/writing data.

2. The method of claim 1, wherein connecting, by the USB composite device, to a host computer and claiming its device type further comprising
claiming, by the USB composite device, itself as a predetermined number of mass storage devices.

3. The method of claim 2, wherein the mass storage device comprising disk and compact disk.

4. The method of claim 2, wherein the operating instruction allocated by the host computer is enclosed according to SCSI protocol.

5. The method of claim 4, wherein determining, by the USB composite device, whether the instruction is key device operating instruction comprising
determining, by the USB composite device, whether the value of specified field of the operating instruction is predetermined value, if the value of specified field of the operating instruction is predetermined value, the instruction is key device operating instruction; otherwise, the instruction is data reading/writing instruction; or
determining, by the USB composite device, whether the value of specified bit of specified field of the operating instruction is predetermined value, if the value of specified bit of specified field of the operating instruction is predetermined value, the instruction is key device operating instruction; otherwise, the instruction is data reading/writing instruction; or
determining, by the USB composite device, whether the operating instruction is extended SCSI instruction, if the operating instruction is extended SCSI instruction, the instruction is key device operating instruction; otherwise, the instruction is data reading/writing instruction.

6. The method of claim 5, wherein
the specified field of the operating instruction is LUN field, reserved field or LAB field of the operating instruction;
the specified bit of the specified field of the operating instruction is special bit of LUN field, special bit of reserved filed or reserved bit of other field.

7. The method of claim 1, wherein connecting, by the USB composite device, to a host computer and claiming its device type further comprising
claiming, by the USB composite device, itself as a HID device and a predetermined number of mass storage devices.

8. The method of claim 7, wherein receiving, by the USB composite device, operating instruction allocated by the host computer and determining whether the instruction is key device operating instruction comprising
analyzing and determining, by the composite device, whether the operating instruction is enclosed according to SCSI protocol, if so, the operating instruction is data reading/writing instruction; otherwise the operating instruction is key device operating instruction; or determining, by the composite device, whether the operating instruction is transferred in by USB control transfer channel, if the operating instruction is transferred in by USB control transfer channel, the operating instruction is key device operating instruction; if the operating instruction is not transferred in by USB control transfer channel, the operating instruction is read/write instruction.

9. The method of claim 1, wherein connecting, by the USB composite device, to a host computer and claiming its device type comprising
claiming, by the composite device, as a Chip/Smart Card Interface Device and a predetermined number of mass storage devices.

10. The method of claim 9, wherein receiving, by the USB composite device, operating instruction allocated by the host computer and determining whether the instruction is key device operating instruction comprising
analyzing and determining whether the operating instruction is enclosed according to SCSI protocol, if the operating instruction is enclosed according to SCSI protocol, the operating instruction is read/write instruction; if the operating instruction is not enclosed according to SCSI protocol, the instruction is key device operating instruction.

11. The method of claim 1, wherein the key device operation comprising
digital signature, identity authentication and data encryption/decryption.

12. A USB composite device, wherein the composite device comprising
interface module adapted to communicate with a host computer and perform parsing/enclosure and communication;
instruction determining module adapted to determine operating instruction, which is obtained by parsing the USB data packet by the interface module, is standard SCSI data reading/writing instruction or key device operating instruction;
data storage module adapted to store data and perform operation of reading/writing data if the operating instruction is standard SCSI data reading/writing instruction; and
key device module adapted to perform key device operation if the operating instruction is key device operating instruction.

13. The USB composite device of claim 12, wherein the key device module further comprising
digital signature unit adapted to sign the data transferred in according to the signing instruction of the key device operating instruction.

14. The USB composite device of claim 12, wherein the key device module further comprising
identity authentication unit adapted to perform operation of identity authentication according to the identity authenticating instruction of the key device operating instruction.

15. The USB composite device of claim 12, wherein the key device module further comprising
data encrypting/decrypting unit adapted to perform operation of encryption/decryption on the data transferred in/out according to the data encrypting/decrypting instruction of the key device operating instruction; and further adapted to perform operation of encryption/decryption on the data transferred in/out from the data storage module.
